(19) United States
(12) Patent Application Publication
(10) Pub. No.: US 2018/0330235 A1
(43) Pub. Date: Nov. 15, 2018

(54) Apparatus and Method of Using Dual Indexing in Input Neurons and Corresponding Weights of Sparse Neural Network

(71) Applicants: National Taiwan University, Taipei City (TW); MEDIATEK INC., Hsin-Chu (TW)

(72) Inventors: Chien-Yu Lin, Kaohsiung City (TW); Bo-Cheng Lai, Hualien County (TW)

(21) Appl. No.: 15/594,667

(22) Filed: May 15, 2017

(51) Int. Cl. G06N 3/08; G06N 3/04; G06F 17/16

(52) U.S. Cl. CPC G06N 3/08; G06F 17/16; G06N 3/04

(57) ABSTRACT

An apparatus includes a memory unit configured to store nonzero entries of a first array and nonzero entries of a second array based on a sparse matrix format; and an index module configured to select the common nonzero entries of the neurons and the corresponding weights. Since the values of the nonzero entries of the neurons and corresponding weights are selected and accessed, the data load and movement from the memory unit can be reduced to save power consumption. In addition, for a sparse neuronal network model with a large scale, through the operations of the index module, the computation regarding a great amount of zero entries can be scattered to improve overall computation speed of a neural network.

### BACKGROUND OF THE INVENTION

### 1. Field of the Invention

The present invention relates to an apparatus and method of using dual indexing in input neurons and corresponding weights of a sparse neural network.

### 2. Description of the Prior Art

A neural network (NN) is widely used in machine learning, in particular a convolutional neural network (CNN) achieves significant accuracy in fields of image recognition or classification, computer visualization, object detection and speech recognition. Therefore, the convolutional neural network is popularly applied in the industry.

The neural network includes a sequence of layers, and every layer of the neural network includes an interconnected group of artificial neurons using a 3-dimensional matrix to store trainable weight values. In other words, the weight values stored with the 3-dimensional matrix is regarded as a neural network model corresponding to the input neurons. Each layer receives a group of input neurons, and transforms the input neurons to a group of output neurons through a differentiable function. This is performed mathematically by a convolution operation that performs a dot product operation to the input neurons and weights of input neurons (i.e., the neural network model).

The increase in the number of neurons implies the need to consume a large amount of storage resources when running the functions of the corresponding neural network model. The data exchange between a computing device and a storage device needs a lot of bandwidth, which takes time to deal with computations. Therefore, the realization of the neural network model has become a bottleneck for a mobile device. Further, a lot of data exchange and extensive use of storage resources also consume higher power, which becomes more and more critical to the battery life of the mobile device.

Recently, researchers are dedicated to reduce the size of input neurons and corresponding neural network model, so as to reduce the overhead of the computation, data exchange and the storage resources. For a sparse input neuron matrix and corresponding sparse neural network model, the convolutional operation regarding the entries (either input neuron or the weight corresponding to the input neuron) with zero value can be scattered to eliminate computation overheads, reduce data movement and save storage resource, thereby improving computation speed and reducing power consumption.

To generate the sparse neural network model, specific reduction algorithms (e.g., network pruning) are independently performed to them, which independently changes the distribution of the nonzero entries of the sparse input neurons and the corresponding sparse neural network model.

For example, the distance between two nonzero entries of the input neurons or the weights is not continuous, and the distributions of the nonzero entries of the input neurons and the corresponding weights are independent. Therefore, it has become a topic to find the location of the nonzero entries of the input neurons and the corresponding weights.

### SUMMARY OF THE INVENTION

It is therefore an objective of the present invention to provide an apparatus and method of using dual indexing in input neurons and corresponding weights of a sparse neural network.

The present invention discloses an apparatus includes a memory unit and an index module. The memory unit is configured to store a first value array including nonzero entries of a first array and a second value array including nonzero entries of a second array based on a sparse matrix format, store a first index array corresponding to the first array and a second index array corresponding to the second array. The index module is coupled to the memory unit, and includes a first accumulated ADD unit, a second bitwise AND unit and a first multiplex unit. The first bitwise AND unit is coupled to the memory unit, and configured to perform a first bitwise AND operation to the first index array and the second index array to generate a common nonzero index array. The first accumulated ADD unit is coupled to the memory unit and the first bitwise AND unit, and configured to perform an accumulated ADD operation to the first index array to generate a first offset array. The second bitwise AND unit is coupled to the first accumulated ADD unit and the first bitwise AND unit, and configured to perform a second bitwise AND operation to the first offset array and the common nonzero index array to generate a first nonzero offset array. The first multiplex unit is coupled to the second bitwise AND unit and the memory unit, and configured to select common nonzero entries from the first value array according to the first nonzero offset array.

The present invention further discloses a method includes storing nonzero entries of a first array and nonzero entries of a second array based on a sparse matrix format, storing a first index array corresponding to the first array and a second index array corresponding to the second array, performing a first bitwise AND operation to the first index array and the second index array to generate a common nonzero index array, performing an accumulated ADD operation to the first index array to generate a first offset array, performing a second bitwise AND operation to the first offset array and the common nonzero index array to generate a first nonzero offset array, and selecting common nonzero entries from the first array according to the first nonzero offset array.

The present invention utilizes indices to indicate nonzero and zero entries of the input neurons and the corresponding weights in search of the common nonzero entries of the neurons and the corresponding weights. The index module of the present invention selects the common nonzero entries of the neurons and the corresponding weights. Since the values of the nonzero entries of the neurons and corresponding weights are selected and accessed, the data load and movement from the memory unit can be reduced to save power consumption. In addition, for a sparse neuronal network model with a large scale, through the operations of the index module, the computation regarding a great amount of zero entries can be scattered to improve overall computation speed of a neural network.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates an architecture of a neural network.

FIG. 2 is a functional block diagram of an index module according to an embodiment of the present invention.

FIG. 3A to FIG. 3E illustrate operations of the index module of FIG. 2 according to an embodiment of the present invention.

FIG. 4 is a functional block diagram of an index module according to another embodiment of the present invention.

FIG. 5 is a flow chart of a process according to an embodiment of the present invention.

### DETAILED DESCRIPTION

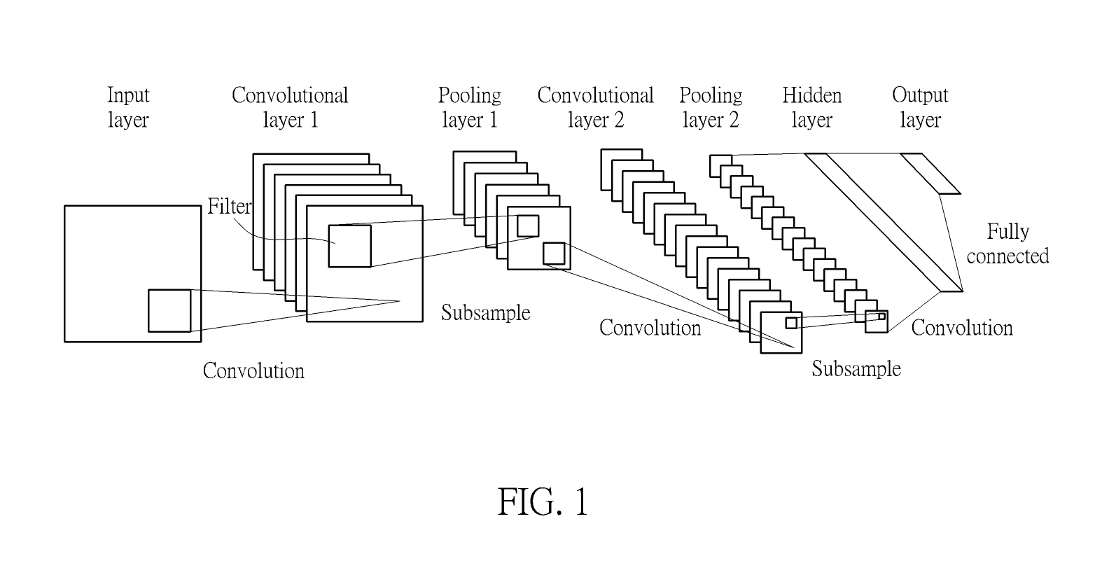

FIG. 1 illustrates an architecture of a convolutional neural network. The convolutional neural network includes a plurality of convolutional layers, pooling layers and fully-connected layers.

The input layer receives input data, e.g. an image, and is characterized by dimensions of N×N×D, where N represents height and width, and D represents depth. The convolutional layer includes a set of learnable filters (or kernels), which have a small receptive field, but extend through the full depth of the input volume. Each filter of the convolutional layer is characterized by dimensions of K×K×D, where K represents height and width of each filter, and the filter has the same depth D with input layer. Each filter is convolved across the width and height of the input volume, computing the dot product between the entries of the filter and the input and producing a 2-dimensional activation map of that filter. As a result, the network learns filters that activate when it detects some specific type of feature at some spatial position in the input data.

The pooling layer performs down-sampling and serves to progressively reduce the spatial size of the representation, to reduce the number of parameters and the amount of computation in the network. It may be common to periodically insert a pooling layer between successive convolutional layers. The fully-connected layer represents the class scores, for example, in image classification.

It may also be common to periodically insert a rectified linear unit (abbreviated ReLU) as an activation function between the convolutional layer and the pooling layer to increases the nonlinear properties of the decision function and of the overall network without affecting the receptive fields of the convolutional layer. The ReLU activation function may cause neuron sparsity at runtime since lots of zeros to the neurons are generated after passing through the ReLU activation function. It has been shown that around 50% of the neurons are zeros for some state-of-the-art DNNs, e.g., AlexNet.

Note that network pruning is a technique that reduces the size of the neural network by setting the value of weights that provide little power to classify instances to be zero, so as to prune unneeded connections between neurons for network compression. For large-scale neural networks after the network pruning, there is a significant amount of sparsity for the weights (filters, synapse or kernels), i.e., many entries of the neural network are with zero value. Operations regarding the zero entries can be scattered to eliminate computation overheads, reduce data movement and save storage spaces and resources, so as to improve overall computation speed and reduce power consumption of the neural network.

To take the advantages of the sparsity for the weights (filters, synapse or kernels) and neurons, the present invention utilizes an index module to find the locations of the input neurons and the corresponding weights with nonzero values.

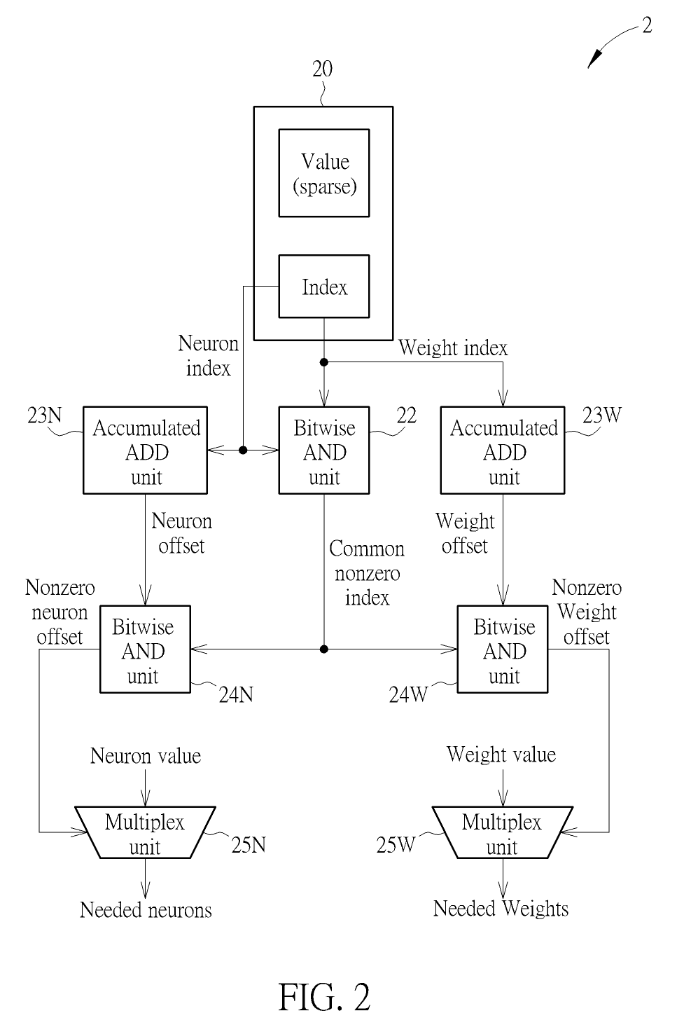

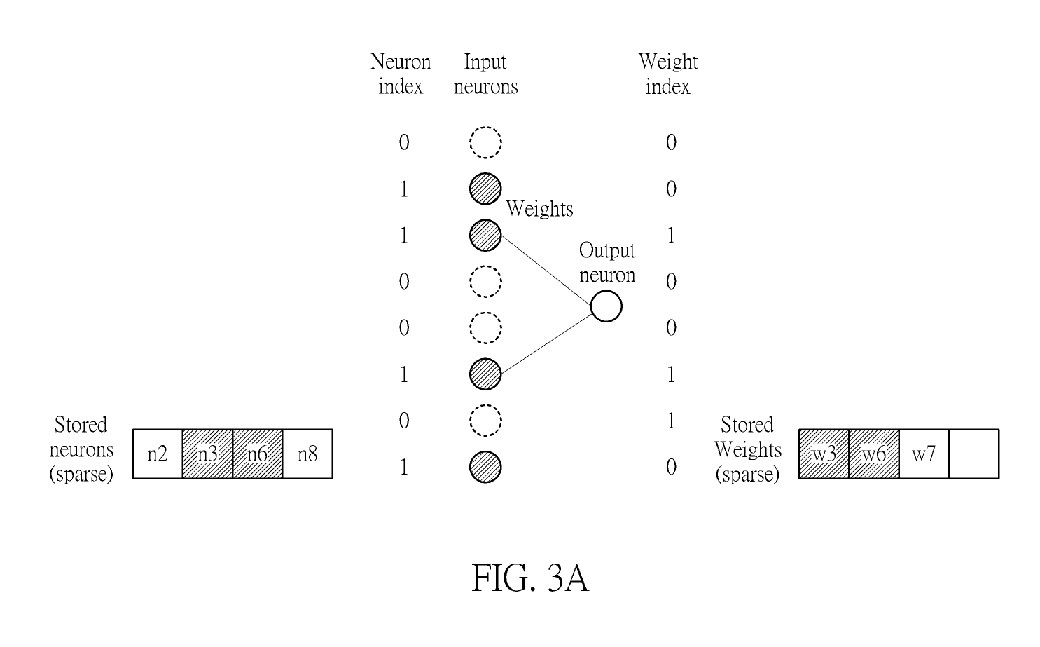

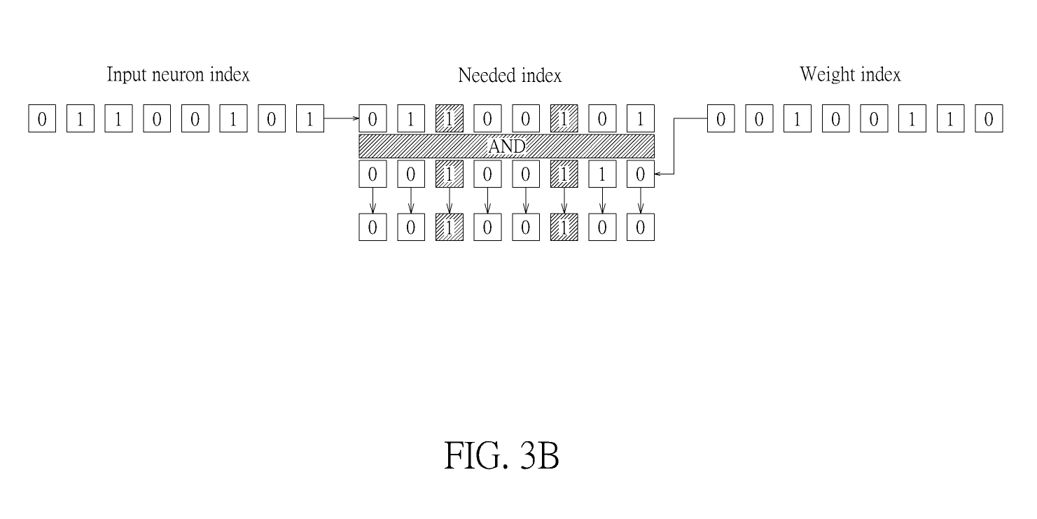

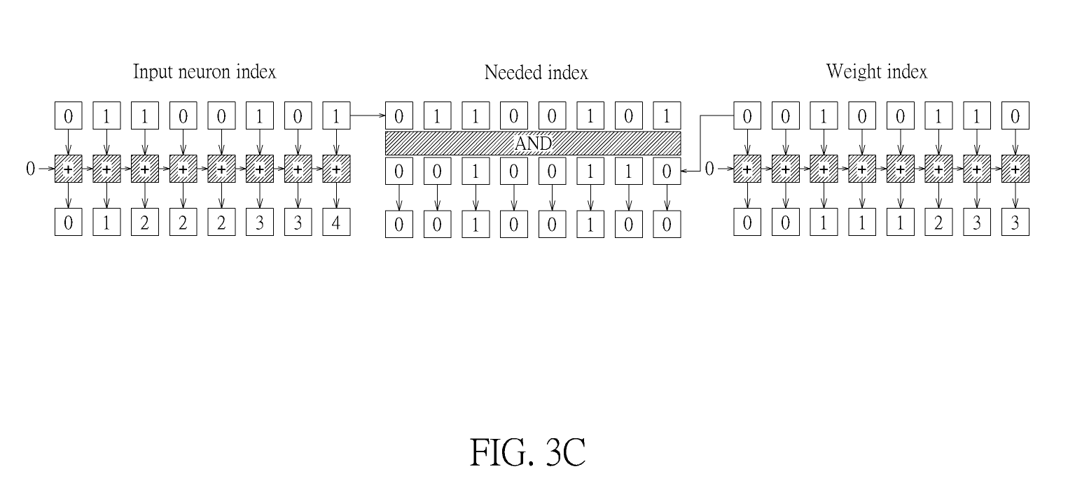

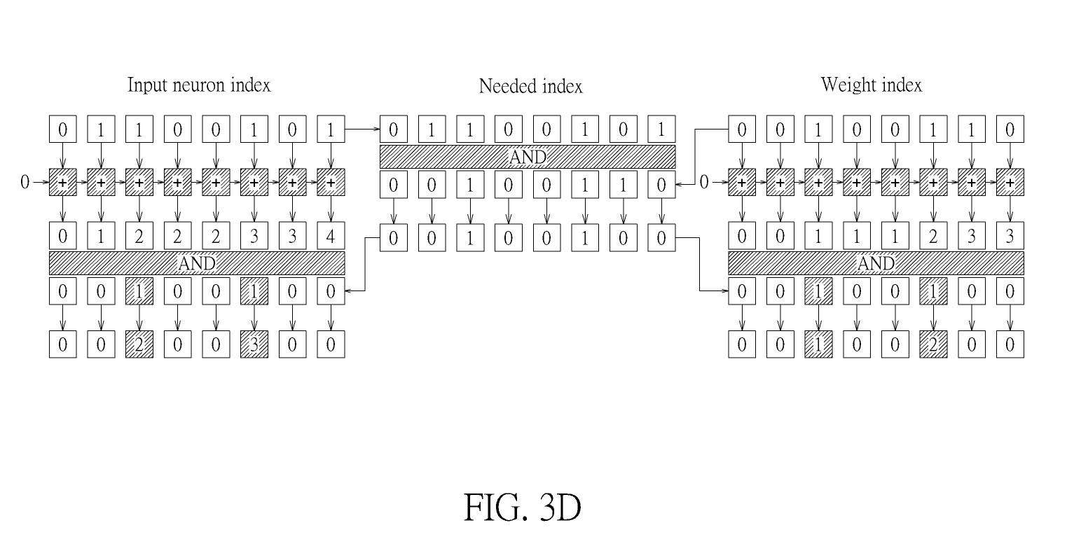

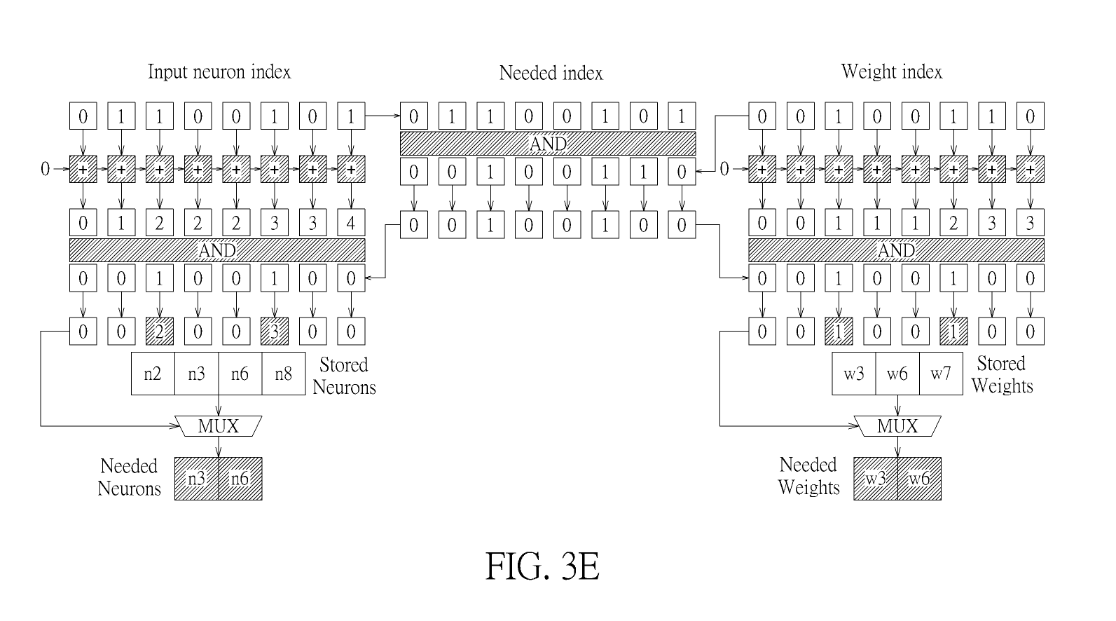

FIG. 2 is a functional block diagram of an index module 2 according to an embodiment of the present invention. FIG. 3A to FIG. 3E illustrate operations of the index module 2 according to an embodiment of the present invention. In FIG. 2, the index module 2 includes a memory unit 20, bitwise AND unit 22, 24N and 24W, accumulated ADD units 23N and 23W, and multiplex units 25N and 25W.

In FIG. 3A, the memory unit 20 is configured to store the nonzero entries of neurons and corresponding weights of a neural network based on a sparse matrix format. For example, compressed column sparse (CCR) stores a matrix using three 1-dimensional arrays including (1) a value array corresponding to nonzero values of the matrix, (2) an indices array corresponding to the location of nonzero values in each column, and (3) an indices pointer array pointing to column starts in the value and indices arrays. In this embodiment, the neuron array and the weight array are pair-wise input elements with identical data structure and equal data size, to be inputted to the index module 2.

Given a neuron array [0, n2, n3, 0, 0, n6, 0, n8] and a weight array [0, 0, w3, 0, 0, w6, w7, 0], wherein the neurons n1, n4, n5, and n7, the weights w1, w2, w4, w5 and w8 are non-zero entries. In this embodiment, the neuron array [0, n2, n3, 0, 0, n6, 0, n8] is stored in the memory unit 20 with a neuron value array [n2, n3, n6, n8] and the weight array [0, 0, w3, 0, 0, w6, w7, 0] is stored in the memory unit 20 with a weight value array [w3, w6, w7] under the given condition.

The memory unit 20 is further configured to store a neuron index array corresponding to the neuron array and a weight index array corresponding to the weight array. In an embodiment, the value of the neuron indices and the weight indices are stored with binary representation or Boolean representation with 1-bit. For example, the value of the index is binary 1 if the entry of the neuron or the weight has a nonzero value, while the value of the index is binary 0 if the entry of the neuron or the weight has a zero value. Using the index with 1-bit to specify the entry of interest and non-interest (e.g., nonzero and zero entries) can be referred as direct indexing. In an embodiment, step indexing is feasible to remark the entries of interest and non-interest (e.g., nonzero and zero entries).

For example, the neuron array [0, n2, n3, 0, 0, n6, 0, n8] is corresponding to a neuron index array [0, 1, 1, 0, 0, 1, 0, 1], and the weight array [0, 0, w3, 0, 0, w6, w7, 0] is corresponding to a weight index array.

In FIG. 3B, the bitwise AND unit 22 is coupled to the memory unit 20, and configured to perform a bitwise AND operation to the neuron array and the weight array in search of the index indicating both of the neuron and the corresponding weight with nonzero values. In detail, the bitwise AND operation takes two arrays with equal-length and binary representation from the memory unit 20, and performs the logical AND operation on each pair of the corresponding bits, by multiplying them. Thus, if both bits in the corresponding location are binary 1, the bit in the resulting binary representation is binary 1 (1×1=1); otherwise, the bit in the resulting binary representation is binary 0 (1×0=0 and 0×0=0). For example, the bitwise AND unit 22 multiplies the neuron index array [0, 1, 1, 0, 0, 1, 0, 1] with the weight index array [0, 0, 1, 0, 0, 1, 1, 0] to generate a common nonzero index array [0, 0, 1, 0, 0, 1, 0, 0].

In FIG. 3C, the accumulated ADD unit 23N is coupled to the memory unit 20, and configured to perform an accumulated ADD operation to the neuron index array [0, 1, 1, 0, 0, 1, 0, 1] to accumulate them. The accumulated ADD unit 23W is coupled to the memory unit 20, and configured to perform an accumulated ADD operation to the weight index array [0, 0, 1, 0, 0, 1, 1, 0] to accumulate them. For example, the neuron index array [0, 1, 1, 0, 0, 1, 0, 1] is accumulated by the accumulated ADD unit 23N to generate a neuron offset array [0, 1, 2, 2, 2, 3, 3, 4], and the weight index array [0, 0, 1, 0, 0,1, 1, 0] is accumulated by the accumulated ADD unit 23W to generate a weight offset array [0, 0, 1, 1, 1, 2, 3, 3]. In an embodiment, the accumulated ADD units 23N and 23W generate a default bit with binary 0 to be added with the left most bit of the inputted array.

In an embodiment, the bitwise AND unit 22 and the accumulated ADD units 23N and 23W may be operative simultaneously to save compute time, since their operations involve the same input arrays but are independent.

In FIG. 3D, the bitwise AND unit 24N is coupled to the accumulated ADD unit 23N, and configured to perform a bitwise AND operation to the neuron offset array [0, 1, 2, 2, 2, 3, 3, 4] and the common nonzero index array [0, 0, 1, 0, 0, 1, 0, 0] to generate a nonzero neuron offset array [0, 0, 2, 0, 0, 3, 0, 0]. The bitwise AND unit 24W is coupled to the accumulated ADD unit 23W, and configured to perform the bitwise AND operation to the common nonzero index array [0, 0, 1, 0, 0, 1, 0, 0] and the weight offset array [0, 0, 1, 1, 1, 2, 3, 3] to generate a nonzero weight offset array [0, 0, 1, 0, 0, 2, 0, 0].

Note that the neuron (weight) offset array indicates the order (herein called “offset”) of the nonzero entries in the neurons (weight). For example, the neurons n2, n3, n6, and n8 is the first to fourth nonzero entry of the neuron array [0, n2, n3, 0, 0, n6, 0, n8], respectively. The weights w3, w6, and w7 is the first to third nonzero entry of the weight array [0, 0, w3, 0, 0, w6, w7, 0], respectively.

Through the operation of the bitwise AND units 24N and 24W, the required offset (i.e., the order of nonzero entries) of the neuron array and the weight array are kept, and set the rest of offsets to be zero, which is benefit for locating the nonzero entries of the neuron array and the weight array from the sparse format. For example, the offsets of the neurons n3 and n6 indicate the second and third entries of the neuron value array [n2, n3, n6, n8] with sparse format, and the offsets of the weight w3 and w6 indicate the first and second entries of the weight value array [w3, w6, w7] with sparse format.

In FIG. 3E, the multiplex unit 25N is coupled to the bitwise AND unit 24N, and configured to select the needed entries from the neuron value array [n2, n3, n6, n8] stored in the memory unit 20 according to the nonzero neuron offset array [0, 0, 2, 0, 0, 3, 0, 0], in this case the neurons n3 and n6 are selected. The multiplex unit 25W is coupled to the bitwise AND unit 24W, and configured to select the needed entries from the weight value array [w3, w6, w7] stored in the memory unit 20 according to the nonzero weight offset array [0, 0, 1, 0, 0, 2, 0, 0], in this case the weights w3 and w6 are selected.

Therefore, through the operations of the index module 2, since the values of the nonzero entries of the neurons and corresponding weights are selected and accessed, the data load and movement from the memory unit 20 can be reduced to save power consumption. In addition, for a sparse neuronal network model with a large scale, through the operations of the index module 2, the computation regarding a great amount of zero entries can be scattered to improve overall computation speed of the neural network.

As observed from FIG. 2, the architecture of the index module 2 is quiet symmetric, and as observed from FIG. 3C to FIG. 3E that the bitwise AND units 24N and 24W, the accumulated ADD units 23N and 23W, and the multiplex units 25N and 25W perform the same operations to the neurons and the weights, respectively (parallel computing). It is feasible to use hardware pipeline and pipelining to perform the same operations at the same time, to speed up computation of the index module 2. Alternatively, it is also feasible to use software pipelining to perform the same operations in two computation loops with the same hardware circuit, since the abovementioned units perform simple hardware operation with fast computation speed, which makes minor effect to the computation speed and reduces hardware areas to save cost.

For example, it is feasible to allow the needed neurons or the weights to be fetched while the hardware units are performing arithmetic operations, holding them in a buffer close to the hardware units until each operation is performed.

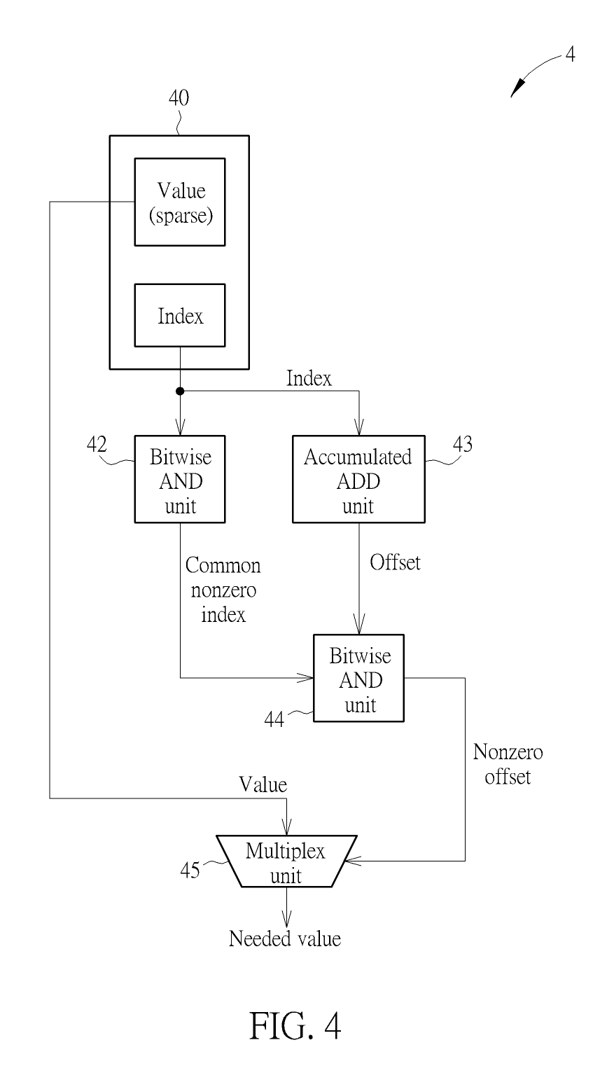

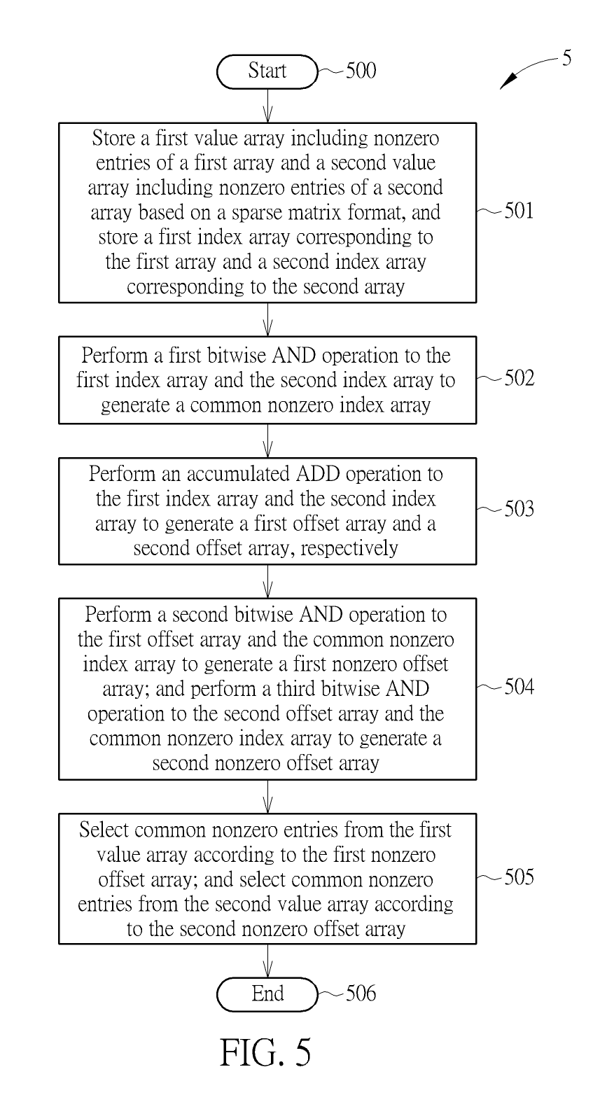

FIG. 4 is a functional block diagram of an index module 4 according to an embodiment of the present invention. The index module 4 includes a memory unit 40, bitwise AND unit 42 and 44, an accumulated ADD unit 43, and a multiplex unit 45.

The memory unit 40 stores a neuron array, a weight array, a neuron value array including nonzero entries of the neuron array, a weight value array including nonzero entries of the weight array based on a sparse matrix format, and store a neuron index array corresponding to the neuron array and a weight index array corresponding to the weight array. The bitwise AND unit 42 reads the neuron index array and the weight index array from the memory unit 40, and performs a bitwise AND operation to the neuron index array and the weight index array to generate a common nonzero index array to the bitwise AND unit 44.

To obtain the needed entries from the neuron array, the accumulated ADD unit 43 reads the neuron index array from the memory unit 40 according to an instruction from a control unit (not shown), and performs an accumulated ADD operation to the neuron index array to accumulate them, to generate a neuron offset array to the bitwise AND unit 44. The bitwise AND unit 44 receives the common nonzero index array from the bitwise AND unit 42 and the neuron offset array from the accumulated ADD unit 43, and performs a bitwise AND operation to the common nonzero index array and the neuron offset array, to generate a nonzero neuron offset array to the multiplex unit 45. The multiplex unit 45 reads the neuron array (sparse format) from the memory unit 40 and the nonzero neuron offset array from the bitwise AND unit 44, to select the needed entries from the neuron array.

Similarly, to obtain the needed entries from the weight array, the accumulated ADD unit 43 reads the weight index array from the memory unit 40 according to another instruction from the control unit (not shown), and performs an accumulated ADD operation to the weight index array to accumulate them, to generate a weight offset array to the AND 44. The AND 44 and the multiplex unit 45 performs exactly the same operations on the basis of the weight offset array, the common nonzero index array, and the weight value array.

Operations of the index modules 2 and 4 can be summarized into a process 5 in search of nonzero entries of the neurons and the corresponding weights. The process includes the following steps:

### Step 500: Start.

Step 501: Store a first value array including nonzero entries of a first array and a second value array including nonzero entries of a second array based on a sparse matrix format, and store a first index array corresponding to the first array and a second index array corresponding to the second array.
Step 502: Perform a first bitwise AND operation to the first index array and the second index array to generate a common nonzero index array.
Step 503: Perform an accumulated ADD operation to the first index array and the second index array to generate a first offset array and a second offset array, respectively.
Step 504: Perform a second bitwise AND operation to the first offset array and the common nonzero index array to generate a first nonzero offset array; and perform a third bitwise AND operation to the second offset array and the common nonzero index array to generate a second nonzero offset array.
Step 505: Select common nonzero entries from the first value array according to the first nonzero offset array; and select common nonzero entries from the second value array according to the second nonzero offset array.

### Step 506: End.

In the process 5, Step 501 is performed by the memory unit 20 or 40; Step 502 is performed by the bitwise AND unit 22 or 42; Step 503 is performed by the bitwise AND units 24N and 24W or 44; Step 504 is performed by the accumulated ADD units 23N and 23W or 43; Step 505 is performed by the multiplex units 25N and 25W or 45. Detailed descriptions of the process 5 can be obtained by referring to the embodiments of FIG. 2 and FIG. 4.

To sum up, the present invention utilizes the index module to select the common nonzero entries of the neurons and the corresponding weights. Since the values of the nonzero entries of the neurons and corresponding weights are selected and accessed, the data load and movement from the memory unit can be reduced to save power consumption. In addition, for a sparse neuronal network model with a large scale, through the operations of the index module, the computation regarding a great amount of zero entries can be scattered to improve overall computation speed of the neural network.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An apparatus of selecting common nonzero entries of two arrays, comprising:
a memory unit configured to store a first value array including nonzero entries of a first array and a second value array including nonzero entries of a second array based on a sparse matrix format, and store a first index array corresponding to the first array and a second index array corresponding to the second array; and
an index module coupled to the memory unit, comprising:
a first bitwise AND unit coupled to the memory unit, and configured to perform a first bitwise AND operation to the first index array and the second index array to generate a common nonzero index array;
a first accumulated ADD unit coupled to the memory unit, and configured to perform an accumulated ADD operation to the first index array to generate a first offset array;
a second bitwise AND unit coupled to the first accumulated ADD unit and the first bitwise AND unit, and configured to perform a second bitwise AND operation to the first offset array and the common nonzero index array to generate a first nonzero offset array; and
a first multiplex unit coupled to the second bitwise AND unit and the memory unit, and configured to select common nonzero entries from the first value array according to the first nonzero offset array.

2. The apparatus of claim 1, wherein the first accumulated ADD unit is further configured to perform the accumulated ADD operation to the second index array to generate a second offset array.

3. The apparatus of claim 2, wherein the second bitwise AND unit is further configured to perform the second bitwise AND operation to the second offset array and the common nonzero index array to generate a second nonzero offset array.

4. The apparatus of claim 3, wherein the first multiplex unit is further configured to select common nonzero entries from the second value array according to the second nonzero offset array.

5. The apparatus of claim 1, wherein the index module further comprises:
a second accumulated ADD unit coupled to the first bitwise AND unit, and configured to perform an accumulated ADD operation to the second index array to generate a second offset array;
a third bitwise AND unit coupled to the second accumulated ADD unit, and configured to perform a third bitwise AND operation to the second offset array and the common nonzero index array to generate a second nonzero offset array; and
a second multiplex unit coupled to the third bitwise AND unit, and configured to select common nonzero entries from the second value array according to the second nonzero offset array.

6. The apparatus of claim 1, wherein the value of the first and second arrays is stored with binary representation or Boolean representation with 1-bit, the value of the index is binary 1 if the entry of the first or second array has a nonzero value, while the value of the index is binary 0 if the entry of the first or second array has a zero value.

7. The apparatus of claim 1, which is utilized in realization of a neural network model, the first array corresponds to a plurality of input neurons of the neural network model, and the second array corresponds to a plurality of weights of the neural network model.

8. The apparatus of claim 1, wherein the first offset array indicates an order of the nonzero entries in the first value array stored with the sparse matrix format.

9. The apparatus of claim 8, wherein the sparse matrix format is a compressed column sparse format.

10. A method of selecting common nonzero entries of two arrays, comprising:
storing a first value array including nonzero entries of a first array and a second value array including nonzero entries of a second array based on a sparse matrix format, and a first index array corresponding to the first array and a second index array corresponding to the second array;
performing a first bitwise AND operation to the first index array and the second index array to generate a common nonzero index array;
performing an accumulated ADD operation to the first index array to generate a first offset array;
performing a second bitwise AND operation to the first offset array and the common nonzero index array to generate a first nonzero offset array; and
selecting common nonzero entries from the first array according to the first nonzero offset array.

11. The method of claim 10, further comprising:
performing the accumulated ADD operation to the second index array to generate a second offset array.

12. The method of claim 10, further comprising:
performing the second bitwise AND operation to the second offset array and the common nonzero index array to generate a second nonzero offset array.

13. The method of claim 12, further comprising:
selecting common nonzero entries from the second array according to the second nonzero offset array.

14. The method of claim 10, wherein the value of the first and second arrays is stored with binary representation or Boolean representation with 1-bit, the value of the index is binary 1 if the entry of the first or second array has a nonzero value, while the value of the index is binary 0 if the entry of the first or second array has a zero value.

15. The method of claim 10, which is utilized in realization of a neural network model, the first array corresponds to a plurality of input neurons of the neural network model, and the second array corresponds to a plurality of weights of the neural network model.

16. The method of claim 10, wherein the first offset array indicates an order of the nonzero entries in the first value array stored with the sparse matrix format.

17. The method of claim 16, wherein the sparse matrix format is a compressed column sparse format.
